(19) United States
(12) Patent Application Publication
(10) Pub. No.: US 2024/0265411 A1
(43) Pub. Date: Aug. 8, 2024

(54) COLLABORATIVE MARKETING SYSTEMS AND METHODS

(71) Applicants: Erik Jensen, Herriman, UT (US); Austin Larsen, Herriman, UT (US); Jeff Wilbur, Herriman, UT (US)

(72) Inventors: Erik Jensen, Herriman, UT (US); Austin Larsen, Herriman, UT (US); Jeff Wilbur, Herriman, UT (US)

(21) Appl. No.: 18/636,944

(22) Filed: Apr. 16, 2024

(51) Int. Cl. G06Q 30/0201; G06Q 10/101

(52) U.S. Cl. CPC G06Q 30/0201; G06Q 10/101

(57) ABSTRACT

Collaborative marketing systems including a processor, an attribution engine, a collaboration engine, and a promoter ecommerce system. The attribution engine, the collaboration engine, and the promoter ecommerce system are in data communication with the processor. The attribution engine includes an attribution memory unit with information about brands and products available to be collaboratively marketed and about entity commissions payable for marketing them. The collaboration engine includes a collaboration memory unit with information about promoters utilizing the collaborative marketing system and their collaborations. The promoter ecommerce system includes a promoter storefront and a collaboration management system. The promoter storefront is accessible to consumer computing devices over a data network. The promoter storefront includes marketing information about a selected brand or product and a commission trigger capturing when a commission trigger event occurs. The collaboration management system manages collaborative marketing by multiple promoters via promoter groups.

### CROSS REFERENCE TO RELATED APPLICATIONS

This application claims priority to copending U.S. application Ser. No. 63/455,183, filed on Apr. 17, 2023, which is hereby incorporated by reference for all purposes.

### BACKGROUND

The present disclosure relates generally to marketing systems and methods. In particular, collaborative marketing systems and methods enabling multiple promoters to promote products collaboratively are described.

Ecommerce systems are an important and ubiquitous way for people to learn about and purchase goods and services. Online storefronts for a particular brand, such as Nike.com for Nike brand products, and online marketplaces for a variety of brands, such as Amazon.com, enable consumers to research and purchase products over the internet as an alternative to brick-and-mortar shopping locations.

Promoting products has evolved beyond brands directly advertising their products. Today, social media influencers (also known as creators, brand ambassadors, or promoters) are an important avenue for bringing awareness to products and for generating demand for products. Consumers follow individuals they admire or find interesting and are introduced to products and brands promoted by the influencers. Consumer demand often increases for products highlighted by influencers.

Influencers are often compensated by brands for the increased product demand they generate from their popularity and promotion efforts. Various forms of influencer compensation exist, such as provisions of free products and monetary compensation.

Known systems and methods for utilizing promoters are not entirely satisfactory. For example, existing approaches are often limited to a single promoter's activities despite there being benefits to multiple promoters working together collaboratively to promote a product. One benefit to collaborative promotion is greater social impact and perceived popularity from consumers seeing products promoted by multiple influencers. Another benefit to collaborative promotion is enhanced satisfaction and utilization of visibility algorithms with search engines and social media platforms.

Conventional marketing approaches that accommodate multiple promoters to some extent tend to be cumbersome and provide limited capabilities. For example, existing systems allowing for multiple promoters do not allow promoters to readily form, change, or disband collaborative groups. Further, systems existing today do not enable promoters to conveniently set commission parameters for the promoter group. It would be desirable to have a system where promoter groups could easily negotiate and establish commission allocations between the individual promoters of the group.

Further, conventional systems lack means to easily select products to be promoted by the group. Such systems also do not provide an effective way to automatically establish commission parameters for a given product. It would be desirable to have a plug-and-play arrangement where a promoter group could simply select products to promote from a collection of products with commission arrangements automatically established.

Conventional promotion solutions limit the exposure a brand can achieve for its products or make achieving wider exposure difficult and time consuming. Brands recognize that social media influencer promotions can be effective, but establishing relationships with influencers on an individual basis is cumbersome and limiting. Further time and energy is needed for brands attempting to form promoter collaborations. It would be more effective for brands to enlist a large number of individual promoters via a single marketing system and to allow the promoters to form collaboration groups themselves.

Thus, there exists a need for marketing systems and methods that improve upon and advance the design of known marketing systems and methods. Examples of new and useful collaborative marketing systems and methods relevant to the needs existing in the field are discussed below.

### SUMMARY

The present disclosure is directed to collaborative marketing systems including a processor, an attribution engine, a collaboration engine, and a promoter ecommerce system. The attribution engine, the collaboration engine, and the promoter ecommerce system are in data communication with the processor.

The attribution engine includes an attribution memory unit with attribution data stores. The attribution data stores include a brand data store, a product data store, and an entity commissions data store. The attribution data stores include information about brands and products available to be collaboratively marketed and about entity commissions that commercial entities will pay for marketing them.

The collaboration engine includes a collaboration memory unit including collaboration data stores. The collaboration data stores include information about promoters utilizing the collaborative marketing system and about collaborations among the promoters.

The promoter ecommerce system includes a promoter storefront and a collaboration management system. The promoter storefront is customized by a promoter and accessible to consumer computing devices over a data network.

The promoter storefront includes marketing information and a commission trigger. The marketing information derives from a promoter and pertains to a selected brand or product from the attribution data stores. The commission trigger captures when a commission trigger event occurs for the selected brand or product.

The collaboration management system is configured to manage collaborative marketing by multiple promoters via promoter groups.

### BRIEF DESCRIPTION OF THE DRAWINGS

FIG. 1 is a schematic view of a first example of a collaborative marketing system facilitating collaborative marketing among multiple promoters.

FIG. 2 is a schematic view of the collaborative marketing system shown in FIG. 1 depicting a collaboration engine and an attribution engine in more detail.

FIG. 3 is a flow diagram of a collaboration method executed by the collaboration engine via computer executable instructions.

FIG. 4 is a view of a user interface of the collaborative marketing system for selecting, creating, and deleting promoter groups.

FIG. 5 is a view of a user interface of the collaborative marketing system for adding new promoters to a particular promotion group.

FIG. 6 is a view of a user interface of the collaborative marketing system for managing commission parameters of a particular promotion group.

FIG. 7 is a view of a user interface of the collaborative marketing system for managing brands promoted by a particular promotion group.

FIG. 8 is a view of a commission share interface of the collaborative marketing system.

FIG. 9 is a view of a promoter storefront of the collaborative marketing system displaying product listings.

FIG. 10 a view of a promoter storefront of the collaborative marketing system displaying a social media post.

### DETAILED DESCRIPTION

The disclosed collaborative marketing systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various collaborative marketing systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device exchanges information with another electronic device, either wirelessly or with a wire-based connector, whether directly or indirectly through a communication network.

“Controllably coupled” means that an electronic device controls operation of another electronic device.

### Collaborative Marketing Systems and Methods

With reference to the figures, collaborative marketing systems and methods will now be described. The collaborative marketing systems and methods discussed herein enable multiple promoters to promote products collaboratively. Further, the collaborative marketing systems and methods described below enable commercial entities and groups of promoters to readily enter into commission arrangements for promoting and selling products.

The reader will appreciate from the figures and description below that the presently disclosed collaborative marketing systems and methods address many of the shortcomings of conventional marketing systems and methods. For example, the novel collaborative marketing systems and methods discussed herein enable commercial entities and promoters to realize the benefits of multiple promoters working together collaboratively to promote a product. With the novel systems and methods herein, promoters and commercial entities can have greater social impact and perceived popularity from consumers seeing products promoted by multiple influencers. Further, promoters and commercial entities can more effectively satisfy and utilize visibility algorithms of search engines and social media platforms from the collaborative marketing enabled by these novel systems and methods.

The novel collaborative marketing systems discussed below allow promoters to readily form, change, or disband promoter groups. Further, the novel collaborative marketing systems enable promoters to conveniently set commission parameters for the promoter group. For example, the novel collaborative marketing systems allow promoter groups to easily negotiate and establish commission allocations between the individual promoters of the group.

The novel collaborative marketing systems discussed herein provide means to easily select products to be promoted by the group. The novel collaborative marketing systems also provide an effective way to automatically establish commission parameters for a given product. Advantageously, the novel collaborative marketing systems enable a promoter group to simply select products to promote from a collection of products with commission arrangements automatically established.

The novel collaborative marketing systems described below expand the exposure a brand can achieve for its products by simplifying the process to utilize groups of promoters working together collaboratively. With the novel collaborative marketing systems, establishing relationships with groups of influencers is straightforward and promoters directly establish advantageous groups themselves. The novel collaborative marketing systems enable commercial entities to enlist a large number of promoters and promoter groups via a single marketing system.

Importantly, the novel collaborative marketing systems and methods discussed herein enable promoters to easily promote products from multiple commercial entities and to sell them in a single consumer transaction. As a result, promoter groups are not constrained to promoting a single brand or required to have separate, brand specific procedures to effectuate sales of products from multiple commercial entities.

Further, the novel collaborative marketing systems and methods provide convenient and robust tools for commercial entities to pay commissions to promoters in promoter groups. The solutions discussed below accommodate commission arrangements for multiple products and brands rather than being limited to a single product or brand. Advantageously, the novel systems and methods do not require fixed agreements between a given commercial entity and promoter or promoter group, but instead allow commission arrangements to be fluidly established based on interest by promoters. With the novel systems and methods below, a promoter group can simply select products to promote from a collection of products with commission arrangements automatically established.

### Contextual Details

Ancillary features relevant to the systems and methods described herein will first be described to provide context and to aid discussing the systems and methods.

### Brand Ecommerce Systems

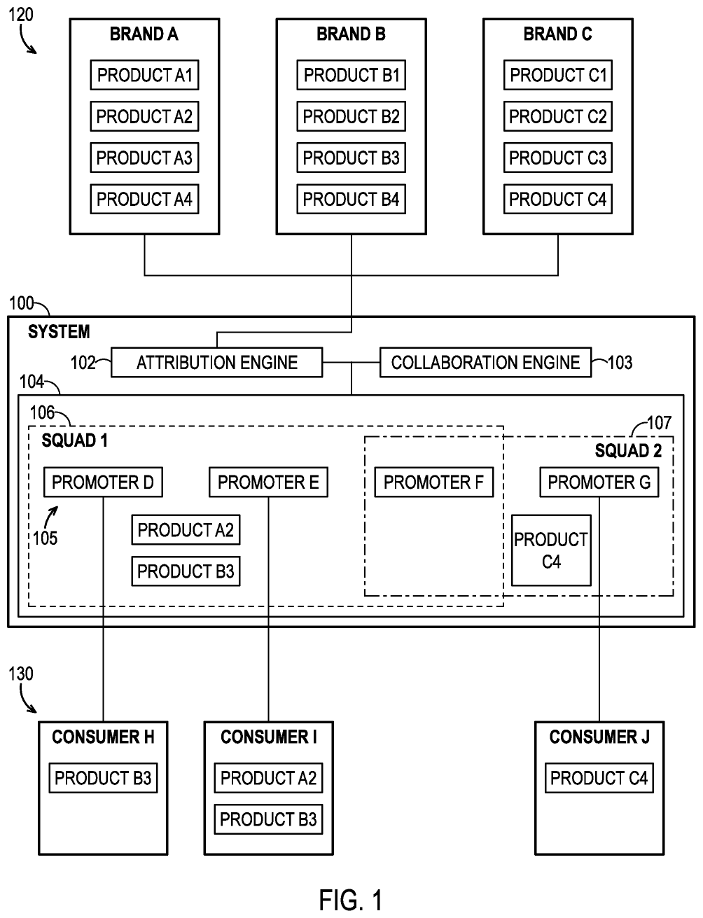

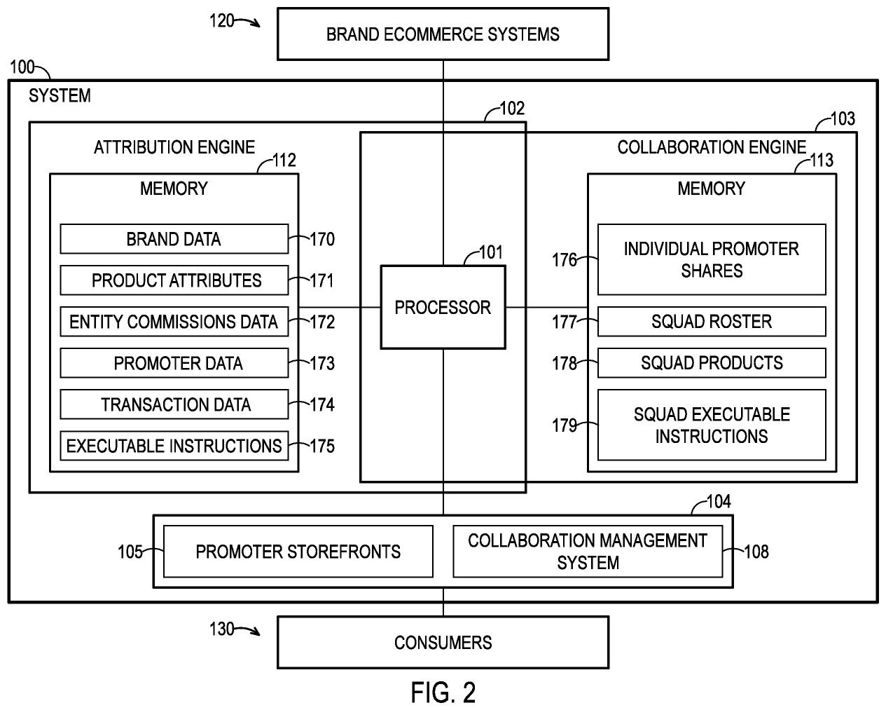

The collaborative marketing systems and methods disclosed herein communicate with ecommerce systems of various commercial entities, also referred to as brands. Representative brand ecommerce systems 120 are depicted in FIGS. 1 and 2. FIG. 1 depicts three brand ecommerce systems 120 in data communication with a collaborative marketing system 100, but the collaboration marketing systems described herein may be in data communication with a plurality of brand ecommerce systems.

The commercial entities may be any current or future provider of goods and services, including manufacturers, distributors, and service providers. A few examples of well-known brands of commercial entities are Nike®, Apple®, and Banana Republic®. The commercial entities may sell or provide a wide variety of goods and services, collectively referred to as products.

The commercial entities utilize collaborative marketing system 100 to enlist promoters to market one or more of their products. For example, FIG. 1 demonstrates that brand A selects products A1-A4 to be marketed via collaborative marketing system 100; brand B selects products B1-B4 to be collaboratively marketed; and brand C selects C1-C4 to be collaboratively marketed via collaborative marketing system 100.

The collaborative marketing systems and methods discussed in this document are configured to work with a wide variety of ecommerce systems utilized by different commercial entities. The novel collaborative marketing systems and methods described below may be in data communication with publicly accessible ecommerce systems of commercial entities or with private (non-publicly accessible) ecommerce systems of commercial entities. Data communication is typically accomplished over the internet and may utilize a wide variety of data protocols.

Commercial entities also utilize the systems and methods discussed in this document to enter into commission arrangements with promoters and/or promoter groups. The commission arrangements may be predetermined and established simply by a promoter group selecting a given product to promote and sell on the individual promoter storefronts of the promoters in a promoter group.

### Promoters

Promoters utilize the systems and methods discussed herein to promote and sell products of various commercial entities to consumers via online storefronts enabled by the systems and methods. Promoters may also be referred to as creators, social media influencers, or brand ambassadors. Promoters typically earn commissions from a commercial entity for effectuating sales of that commercial entity's product or for referring consumers to a commercial entity's brand ecommerce system.

Promoters will utilize the systems and methods described below to form and manage promoter groups to enable them to work together collaboratively to promote and sell products and to earn commissions. Promoter groups may be referred to as promotion groups, squads, or promoter squads.

Promoters also utilize the systems and methods discussed in this document to enter into commission arrangements with commercial entities. The commission arrangements may be predetermined and established simply by a promoter selecting a given product to promote and sell on his or her promoter storefront.

Promoters will typically interact with the systems and methods described below via computing devices with internet connection capabilities, such as smartphones, tablet computers, or personal computers.

### Consumers

Consumers may utilize the novel collaborative marketing systems and methods below to learn about products from promoters. Further, consumers may purchase products of the commercial entities promoted by promoters via promoter storefronts enabled by the systems and methods below.

The consumers may be individuals, businesses, or institutions. Consumers will typically interact with the systems and methods described below via computing devices with internet connection capabilities, such as smartphones, tablet computers, or personal computers.

FIG. 1 schematically depicts three consumer computing devices 130 interacting with collaborative marketing system 100. The reader should understand that collaborative marketing system 100 may be in data communication with a plurality of consumer computing devices. FIG. 2 depicts consumer computing devices 130 collectively interacting with collaborative marketing system 100.

In the example shown in FIG. 1, a consumer H purchases product B3 via his or her consumer computing device 130 interacting with collaborative marketing system 100. In particular, Consumer H interacts with a promoter storefront 105 of promoter D to purchase product B3. Consumer I purchases products A2 and B3 via his or her consumer computing device 130 interacting with a promoter storefront 105 of promoter E in collaborative marketing system 100. Consumer I purchases product C4 via his or her consumer computing device 130 interacting with a promoter storefront 105 of promoter J in collaborative marketing system 100.

### Collaborative Marketing System

With reference to FIGS. 1-10, a first example of a collaborative marketing system, collaborative marketing system 100, will now be described. Collaborative marketing system 100 enables promoters to collaboratively market products and brands of commercial entities to consumers. The reader can see in FIGS. 1 and 2 that collaborative marketing system 100 is in data communication with a plurality of brand ecommerce systems 120 and a plurality of consumer computing devices 130. In the simplified example shown in FIG. 1, collaborative marketing system 100 enables promoters D-G to collaboratively market products of commercial entities A-C to consumers H-J.

As shown in FIG. 1, collaborative marketing system 100 includes a processor 101, an attribution engine 102, a collaboration engine 103, and a promoter ecommerce system 104. Details of attribution engine 102, collaboration engine 103, and promoter ecommerce system 104 are described below and shown in the figures.

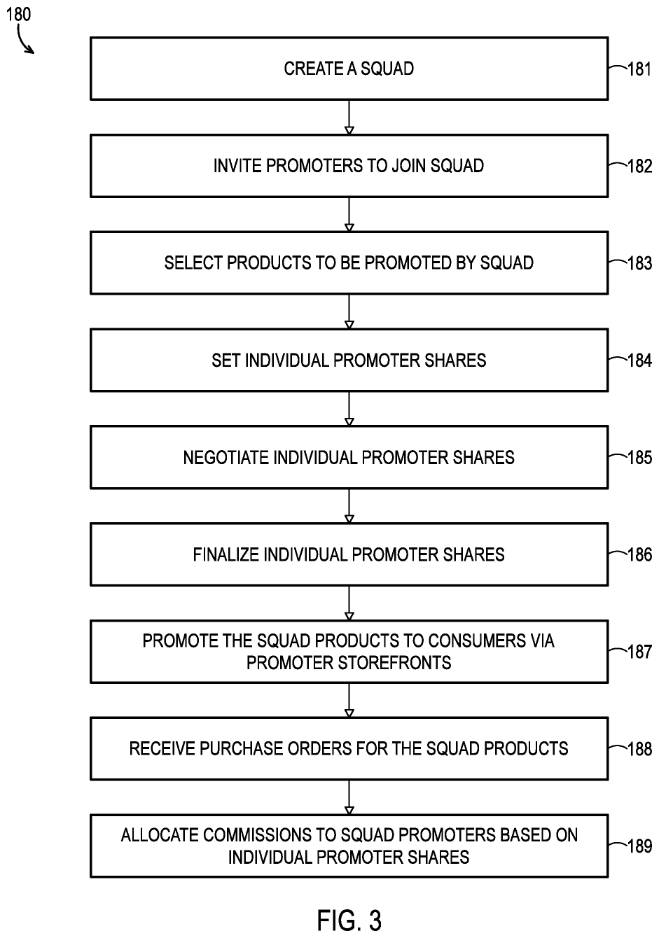

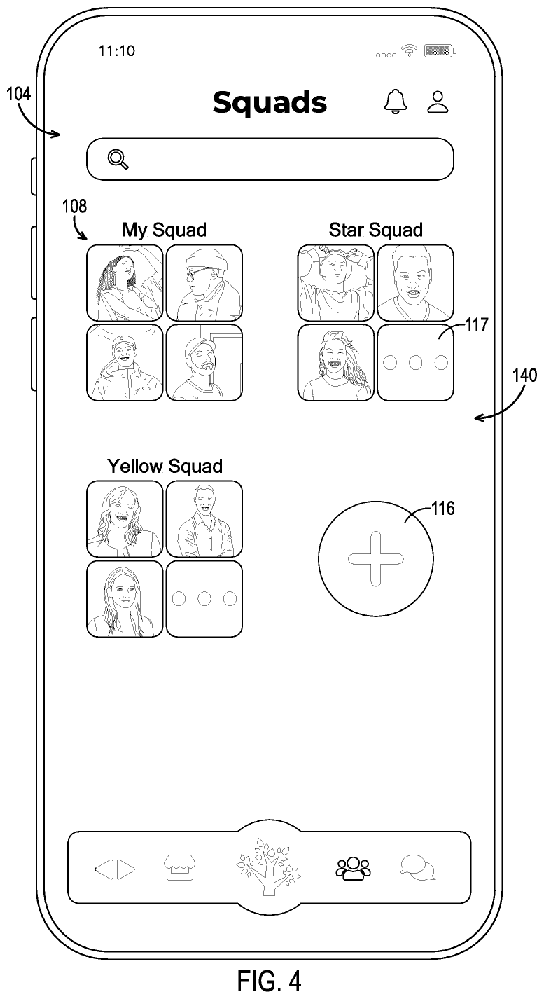

In some examples, the system does not include one or more features shown in FIGS. 1 and 2. Additionally or alternatively, the methods disclosed herein may not include one or more of the method steps shown in FIG. 3. The user interfaces of the collaborative marketing systems contemplated in this disclosure may appear differently than presented in FIGS. 4-10.

In some examples, the systems and methods include additional or alternative features. For example, some system examples include other ecommerce processing engines, such as an order processing engine. The ecommerce processing engines may help facilitate purchase orders, such as to accommodate purchase orders including products from multiple commercial entities. In some examples, the processing engines separate purchase orders with products from multiple commercial entities into suborders specific to a single commercial entity.

### Processor

Processor 101 functions to execute computer executable instructions to enable promoters to collaboratively market brands and products with collaborative marketing system 100. As shown in FIG. 2, processor 101 is in data communication with attribution engine 102, collaboration engine 103, promoter ecommerce system 104, and brand ecommerce systems 120. Processor 101 is also in data communication with consumer computing devices 130 via promoter ecommerce system 104 and may be in direct data communication with the consumer computing devices in some examples.

The processor may be any currently known or later developed type of computer processor or combination of computing devices. Processor 101 is configured to execute computer executable instructions, including the computer executable instructions shown in FIG. 3 comprising a method of promoter collaboration 180.

Promoter Ecommerce System

Promoter ecommerce system 104 enables promoters to collaborate with each other, such as by forming promotion groups and setting individual promoter shares of commissions within promoter groups. Promoter ecommerce system 104 also enables promoters to select products to market and to enter into commission arrangements with commercial entities for marketing the products.

As shown in FIGS. 1 and 2, promoter ecommerce system 104 is in data communication with processor 101, attribution engine 102, and collaboration engine 103. Promoter ecommerce system 104 is also in data communication with consumer computing devices 130. Any currently known or later developed means for promoter ecommerce system 104 to communicate data with other components of collaborative marketing system 100 may be used.

In the present example, promoter ecommerce system 104 includes a promoter storefront 105 and a promoter collaboration management system 108. In particular, promoter ecommerce system 104 includes a promoter storefront 105 and a promoter collaboration management system 108 for each promoter utilizing collaborative marketing system 100. In some examples, the promoter ecommerce system includes fewer, additional, or alternative components. The components of promoter ecommerce system 104 are discussed below.

Promoter ecommerce system 104 includes public pages and private pages. The pubic and private pages may be webpages or screens displayed in a software application, such as a smartphone app. The private pages are accessible by promoters and not displayed to consumers like the public pages.

In the present example, promoter storefronts 105 are comprised of public pages and collaboration management systems 108 are comprised of private pages. For example, promoters can select products of various participating brands to promote and sell via private pages of collaboration management system 108. Additionally or alternatively, the promoters can establish commission arrangements with the participating brands via private pages of collaboration management system 108.

### Promoter Storefronts

Promoter storefronts 105 enable promoters to promote and sell products of various commercial entities utilizing system 100. As shown in FIGS. 1 and 2, promoter storefronts 105 are in data communication with consumer computing devices 130. In particular, promoter storefronts 105 are internet accessible webpages that consumer computing devices 130 may view and interact with using internet enabled devices and web-browsers or specialized software applications, such as smartphone apps.

As shown in FIGS. 1 and 2, promoter storefronts 105 are in data communication with attribution engine 102, collaboration engine 103, and consumer computing devices 130. A consumer may access promoter storefront 105 of a given promoter and submit a purchase order for one or more products from one or more brands listed on promoter storefront 105. Promoter storefront 105 is configured to then send that purchase order to attribution engine 102 to process the order for fulfillment and commission purposes. Collaborative marketing system 100 also sends data to collaboration engine 103 to process commissions within the promoter group.

As shown in FIG. 1, promoter ecommerce system 104 includes a plurality of promoter storefronts 105 (designated in FIG. 1 as promoter D, promoter E, promoter F, and promoter G). The number of promoter storefronts will vary in different examples and may include many more promoter storefronts than depicted in FIG. 1.

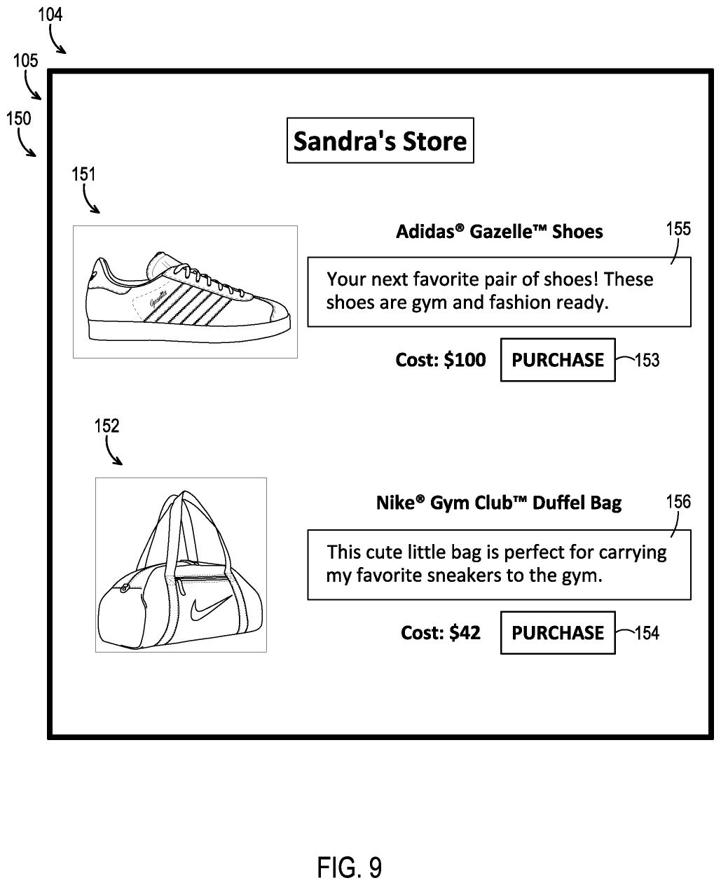

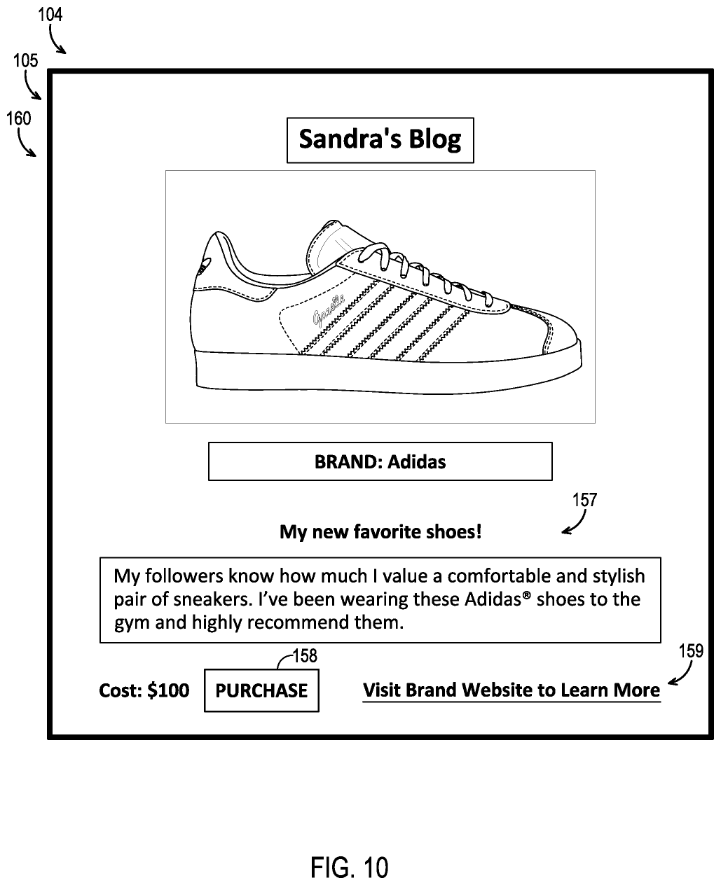

Schematic promoter storefronts 105 are depicted in FIGS. 1 and 2. Examples of two different types of promoter storefronts 105 are shown in FIGS. 9 and 10. FIG. 9 depicts a promoter storefront 150 in the form of an online retail store. FIG. 10 depicts a promoter storefront 160 in the form of a social media post.

Promotor storefronts 105 include marketing information and commission triggers. The marketing information often derives from the promoter and highlights the product or brand being marketed. However, the marketing information may derive from a source other than the promoter, such from a commercial entity or marketing agency.

Commission triggers capture when a commission trigger event occurs for the selected brand or product. A commission trigger event occurs when a consumer purchases a marketed product or clicks a link to visit a brand's ecommerce system 120. A wide variety of other forms of commission trigger events may be defined and utilized by the collaborative marketing systems.

The commission triggers may be buttons, hyperlinks, or other user interface features that a consumer may click or activate with a consumer computing device 130. FIG. 9 depicts two commission triggers 153 and 154 in the form of buttons to purchase products. FIG. 10 also depicts two commission triggers: a first commission trigger 158 in the form of a purchase button and a second commission trigger 159 in the form of a hyperlink to a brand ecommerce system 130 of a commercial entity.

As depicted schematically in FIGS. 1 and 2, the public pages of promoter storefronts 105 are available to consumers to access and view over the internet via consumer computing devices 130. On the public pages of promoter storefronts 105, consumers can view content about the promoters and about the products promoted by the promoters. As shown in promoter storefront 150 depicted in FIG. 9, promoter storefronts 105 may include ecommerce capabilities enabling consumers to purchase products directly from promoter storefronts 105. Further, as shown in promoter storefront 160 depicted in FIG. 10, promoter storefronts 105 may include a wide variety of social networking features, such as blogs, pictures, videos, and chat functions.

Notably, as shown in promoter storefront 150 depicted FIG. 9, promoter storefronts 105 may include products from multiple commercial entities. Consumers may purchase products from multiple commercial entities from a single promoter storefront 105 via a single purchase order transaction.

In the example shown in FIG. 9, a promoter named Sandra has a promoter storefront 150 with a first product listing 151 and a second product listing 152. A consumer may access promoter storefront 150 over the internet via an internet browser on an internet enabled device or via a software application, such as a smart device app. The format of storefront 150 is simplified and serves to demonstrate concepts relevant to the collaborative marketing systems discussed herein. The reader should understand that the storefronts and product listings may be more elaborate, stylized, and/or organized differently.

The product listings visible in promoter storefront 150 depicted in FIG. 9 include two different products available for purchase. The representative products available for purchase in promoter storefront 150 in FIG. 9 are a shoe and a duffel bag. The reader should understand that a consumer may scroll down or otherwise navigate to additional product listings on promoter storefront 150.

As shown in FIG. 9, each product listing includes an image of the product, the brand name for the product, marketing information 155 and 156 directed to the product, the price to purchase the product, and a commission trigger 153 and 154. Other product listing examples may include fewer features, additional features, or alternative features. For example, some product listing examples may include videos of the promoter using or presenting the product.

In the example shown in FIG. 9, marketing information 155 and marketing information 157 derive from the promoter named Sandra. In other examples, the marketing information derives from the commercial entity associated with the product in the product listing, a marketing company, or another party that is not the promoter. The reader should appreciate that the marketing information may be more extensive than the simplified marketing information depicted in FIG. 9.

Commission triggers 153 and 154 are ecommerce buttons each labeled “purchase” in the example shown in FIG. 9. However, the ecommerce buttons may have any suitable label indicating that a consumer may click the button to effectuate a purchase. Suitable labels include “buy now”, “add to cart”, or other customary ecommerce labels.

A separate page in promotor storefront 150 compiles all the products a consumer has elected to purchase in a given session or transaction. The page with all the products to purchase compiled may be referred to as a shopping cart page. By clicking a single button, such as a button labeled “pay now”, the consumer may purchase all the items by submitting payment via an accepted payment method, such as a credit card, electronic funds transfer, and the like.

Notably, the shopping cart page may include products from different commercial entities, and the single pay now button may effectuate the purchase of all products in what appears to be a single transaction to the consumer. The collaborative marketing system may include an order processing engine configured to separate purchase orders encompassing products from multiple commercial entities into suborders specific to a single commercial entity. The order processing engine may be included in the attribution or separate from the attribution engine.

Consider an example where a purchase order including products from five different commercial entities originates as a single transaction from clicking a buy now button on a shopping cart page of a given promoter storefront 105. In such case, the order processing engine divides the purchase order into five suborders. The order processing engine sends the suborders to the respective commercial entities for fulfillment without the consumer necessarily knowing the logistics and without the promotor needing to coordinate the order fulfillment logistics with each commercial entity.

In examples where products from multiple commercial entities are purchased in a single transaction, multiple commission trigger events may occur. For example, an order with products from two different commercial entities may involve two commission trigger events-one for each commercial entity. In the same order example, if a commission trigger event is defined as selling a product for only one of the commercial entities in the order, only one commission trigger event may occur despite two products being sold. Selling the other product may not be defined as a commission trigger event, but the promoter may still sell such products from his or her promoter storefront.

In the example shown in FIG. 9, storefront 150 includes products from two different commercial entities: an Adidas® shoe and a Nike® duffel bag. In some examples, the storefront includes product listings for products from a plurality of commercial entities. In certain examples, the storefront includes products from a single commercial entity.

As FIGS. 1 and 9 and this discussion demonstrate, each promoter storefront 105 may include different numbers of products from different numbers of commercial entities. The reader will appreciate that the system could include many more commercial entities and promoter storefronts than depicted in FIG. 1. In some examples, such as promoter storefront 160 depicted in FIG. 10, a promoter storefront 105 include products from a single commercial entity. In other examples, such as shown in FIGS. 1 and 9, a promoter storefront 105 includes products from multiple commercial entities.

The number of products included in each promoter storefront 105 or in each promoter group can vary. The reader will appreciate that the promoter storefronts and promoter groups may include more or fewer products than represented schematically in FIG. 1.

With reference to FIG. 10, the reader can see that promoter storefront 160 is a social media post marketing a single product. In the example shown in FIG. 10, promoter storefront 160 is a blog of a promoter named Sandra marketing a shoe from the brand Adidas. Promoter storefront 160 includes marketing information 157 created by Sandra. Marketing information 157 includes a heading and narrative text describing Sandra's impression of the shoe and generally promoting the shoe.

As shown in FIG. 10, promoter storefront 160 further includes two commission triggers: a first commission trigger 158 in the form of a button labeled “purchase” and a second commission trigger 159 in the form of a hyperlink to Adidas' brand ecommerce system 120. A consumer clicking first commission trigger 158 will initiate a sales transaction for the shoe. A consumer clicking second commission trigger 159 will browse to a webpage on brand ecommerce system 130 for Adidas to learn more about the shoe and/or purchase it directly from Adidas.

### Promoter Groups

The reader can see in FIGS. 1 and 4-8 that the promoters may be grouped into promoter groups. The promoter groups enable promoters to collaboratively market selected products to consumers. The promoter groups also facilitate sharing commissions earned when one of the promoters in the group effectively markets a product or brand sufficient to cause a commission trigger event to occur. Commission trigger events may occur when a consumer purchases a marketed product or clicks a link to visit a commercial entity's brand ecommerce system 120.

In FIG. 1, promoter groups 106 and 107 are labeled “squads 1” and “squad 2,” respectively. In the example shown in FIG. 1, promoters D, E, and F are in promoter group 106 and promoters F and G are in promoter group 107. As FIG. 1 demonstrates, promoters can be in more than one promoter group with promoter F being in both promoter groups 106 and 107. As depicted in FIGS. 4-8, collaboration management system 108 includes user interfaces for promoters to manage promoter groups.

As shown in FIG. 1, consumer computing devices 130 communicate with promoter storefronts 105 within a promoter group rather than with a promoter group itself. While the systems herein contemplate a promoter group storefront distinct from the individual promoters' storefronts, in the example shown in FIGS. 1 and 2, there is not a promoter group storefront distinct from the individual promoter storefronts 105. Instead, in the present example, consumer computing devices 130 communicate with individual promoter storefronts 105 without regard to promoter groups 106 and 107.

The promoter groupings may be confidential with regard to consumers or may be made apparent to consumers. In the example shown in FIGS. 1 and 2, promoter groups 106 and 107 are not apparent to the consumers. Instead, the consumers interact with individual promoter storefronts 105 without knowing that the promoters are part of a promoter group 106 and/or 107.

In the examples shown in FIG. 1, promoters D, E, and F in promotion group 106 are promoting and selling products A2 and B3 from brands A and B, respectfully. Promoters F and G in promotion group 107 are promoting and selling product C4 from brand C. The products being promoted by promotion groups 106 and 107 appear on storefront pages 105 of each promoter in the promotion group.

For example, the individual promoter storefront page 105 for promoters D, E, and F include products A2 and B3. Promoter F's storefront page 105 also includes product C4. Promoter G's storefront page 105 includes product C4 as well. Promoters D, E, F, and G may include other products not included in their respective promoter groups on their individual storefront pages 105 as well.

### Collaboration Management System

Collaboration management system 108 enables promoters to interact with each other to form promoter groups. Collaboration management system 108 also enables promoters to interact with collaborative marketing system 100, such as to add products or brands to be marketed to promoter groups and/or to establish commission arrangements.

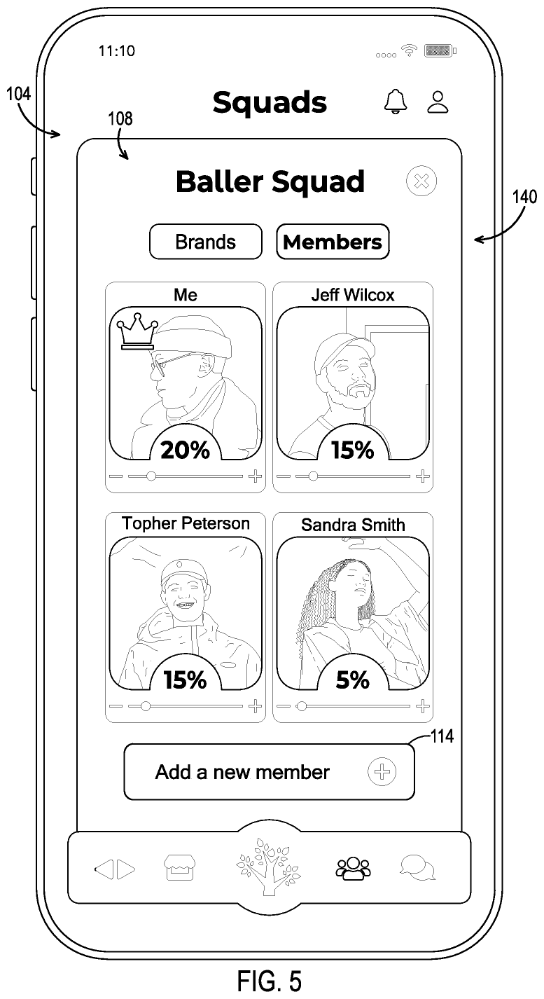

User interfaces for establishing and managing promoter groups are depicted in FIGS. 4-8. User interfaces depicted in FIGS. 4 and 5, which collectively define a collaboration group interface 140, allow promoters to form, change participants of, and disband promoter groups. For example, button 116 on collaboration group interface 140 shown in FIG. 4 enables a promoter to form a new promoter group. Button 117 on collaboration group interface 140 shown in FIG. 4 and button 114 on collaboration group interface 140 shown in FIG. 5 enable a promoter to add a new promoter to a promotion group.

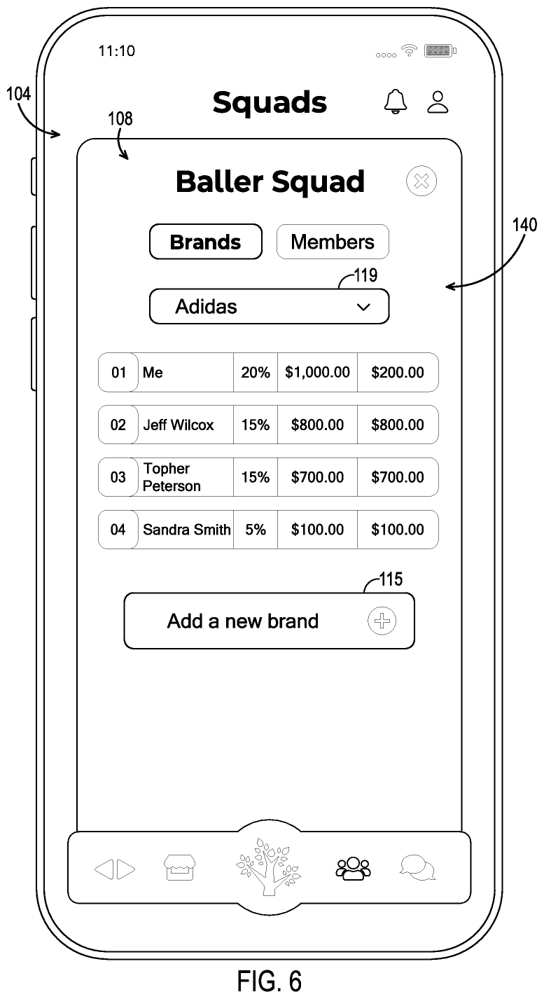

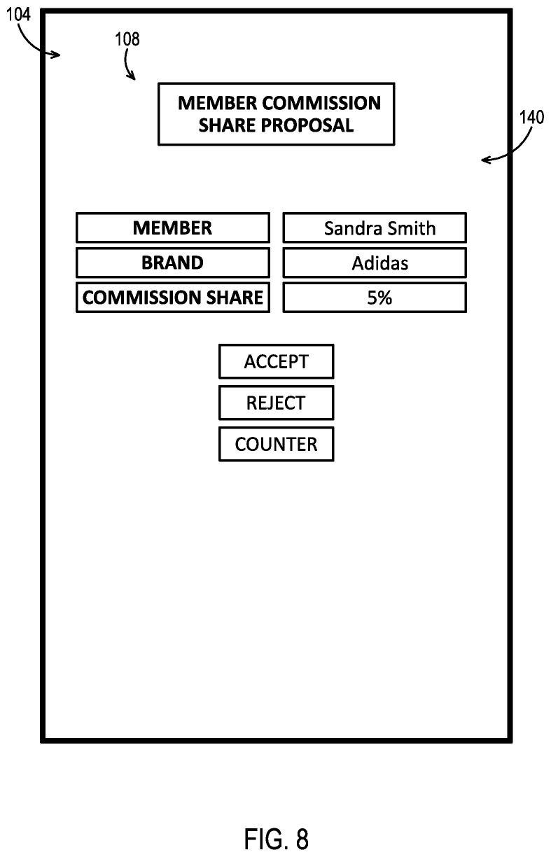

The user interfaces also allow promoters to select products or brands to promote. For example, button 115 on another page of collaboration group interface 140 shown in FIG. 6 enables a promoter to add a new brand or product to be collaboratively marketed by a collaboration group. Further, the user interfaces allow promoter groups to set group commission parameters for the promoter group, including individual promoter commission amounts, referred to here as individual promoter shares. FIG. 8 depicts another page of collaboration group interface 140 configured for setting and negotiating individual promoter shares for a promoter group.

### Attribution Engine

Attribution engine 102 functions to process purchase orders and to determine commissions for promoters or promoter groups based on the purchase orders. Attribution engine 102 also stores commission arrangements established by different commercial entities for their products to be promoted and sold by promoters via collaborative marketing system 100. Further, attribution engine 102 enables promoters to select products they wish to promote and to enter into commission arrangements with commercial entities for promoting those products.

With reference to FIGS. 1 and 2, the reader can see that attribution engine 102 is in data communication with collaboration engine 103 and with brand ecommerce systems 120 utilizing collaborative marketing system 100 via processor 101. With further reference to FIGS. 1 and 2, it is apparent that attribution engine 102 is also in data communication with promoter ecommerce systems 104 via processor 101. Data communication between attribution engine 102 and promoter ecommerce systems 104 enables data communication between attribution engine 102 and the promoters utilizing collaborative marketing system 100.

As shown in FIG. 2, attribution engine 102 includes a memory unit 112 with attribution data stores. Memory unit 112 is in data communication with processor 101 and may be any currently known or later developed type of memory unit.

The reader can see in FIG. 2 that processor 101 is included in both attribution engine 102 and collaboration engine 103 and serves as a shared processor for each engine. However, in other examples, the attribution engine and the collaboration engine have separate processors. In some examples, the system has a processor separate from the processors included in the attribution engine and the collaboration engine.

The reader will understand that the attribution engine may include additional processors and/or memory units. In some examples, the processor and/or the memory unit are in separate physical locations and are in data communication over a data network. The attribution engine may include a wide variety of additional computing device components, such as network cards, random access memory, and graphics processing units.

With reference to FIG. 2, the reader can see that attribution data stores comprised of various data sets and programs are stored in memory unit 112 of attribution engine 102. In the present example, the attribution data stores include brand data 170, product attributes data 171, entity commission data 172, promoter data 173, transaction data 174, and executable instructions 175. Other types of data may be stored in memory unit 112 of attribution engine 102 as well. In some examples, the memory unit of the attribution engine stores only a subset of the data sets and programs depicted in FIG. 2.

Brand data 170 includes various details about the commercial entities utilizing the system. For example, brand data 170 includes credentials and instructions for accessing and interfacing with brand ecommerce systems 120. Brand data 170 also includes information about the commercial entities' utilization of the system, including subscription and fee information, service level details, and promoter roster information.

Product attributes data 171 includes various details about the products of the brands being promoted and sold with promoter ecommerce systems 104. For example, product attributes data 171 includes, as relevant for a given product, product pricing details, product descriptions, product images, product weights, product dimensions, special fulfillment instructions, product promotions, and product variants. Many other details about products could be included in the product attributes data as well.

Entity commissions data 172 specifies the amount of commissions a promoter will earn for promoting a given product sufficient to cause a commission trigger event to occur for the selected brand or product. Expressed another way, an entity commission is an amount of money a commercial entity will pay to have its brand or product marketed sufficient to cause a commission trigger event. A commission trigger event may be selling a product and/or directing a consumer to a brand ecommerce system 130 for the product. A wide variety of entity commission data parameters may apply, such as a fixed commission amount per unit sold, a commission amount based on a percentage of the purchase price for a product, or hybrid commission amounts.

Other commission arrangements not tied strictly to sales of products may be employed as well. For example, a commission arrangement may be based on directing consumers to a brand ecommerce system 130 and/or for promoting in general a brand or specific products. In some instances, a metric of consumer engagement with a promoter's storefront, such as “likes”, page views, or blog comments, may be a parameter used to determine commission amounts.

Promoter data 173 includes various details about the promoters utilizing collaborative marketing system 100. For example, promoter data 173 includes credentials and instructions for promoters to access and interface with promoter ecommerce system 104, including promoter storefronts 105 and collaboration management systems 108. Promoter data 173 also includes information about the promoters' utilization of collaborative marketing system 100, including subscription and fee information, service level details, and brands promoted by the promoters. Performance and consumer popularity and/or engagement information may also be stored in the promoter data.

Transaction data 174 includes details about purchase orders, order fulfillment, and returns. The collaborative marketing system may limit access to the transaction data, such as only allowing the commercial entities and promoters to access transaction data for transactions with which they were involved. The system may also provide consumers with limited access to the transaction data, such as access to the transaction data corresponding to purchase orders and returns the consumers made.

Executable instructions 175 contain various programs and instructions for processor 101 to follow when executing the functions of attribution engine 102. The executable instructions may include all manner of basic operating instructions. Unique to the systems and methods disclosed herein, executable instructions 175 define methods for processing purchase orders and for managing commissions between commercial entities and promoters.

### Collaboration Engine

Collaboration engine 103 functions to store information about promotion groups established in promoter ecommerce systems 104 to support collaboratively marketing products via the promotion groups. Information about the promotion groups stored in collaboration engine 103 include promoters added and removed from promoter groups, products or brands selected for collaborative promotion by the promoter groups, and individual promoter shares established for the promoters in the promotion groups.

With reference to FIGS. 1 and 2, the reader can see that collaboration engine 103 is in data communication with attribution engine 102 via processor 101. With further reference to FIGS. 1 and 2, it is apparent that collaboration engine 103 is also in data communication with promoter ecommerce systems 104 via processor 101. Collaboration engine 103 being in data communication with promoter ecommerce systems 104 enables collaboration engine 103 to exchange data with collaboration management system 108 utilized by the promoters to establish and manage promoter groups.

As shown in FIG. 2, collaboration engine 103 includes processor 101 and a memory unit 113. Processor 101 and memory unit 113 are in data communication and may be any currently known or later developed type of processor and memory unit.

The reader can see in FIG. 2 that attribution engine 102 and collaboration engine 103 share processor 101. However, in other examples, the attribution engine and the collaboration engine have separate processors.

The reader will understand that the collaboration engine may include additional processors and/or memory units. In some examples, the processor and/or the memory unit are in separate physical locations and are in data communication over a data network. The collaboration engine may include a wide variety of additional computing device components, such as network cards, random access memory, and graphics processing units.

With reference to FIG. 2, the reader can see that collaboration data stores comprising various data sets and programs are stored in a memory unit 113. In the present example, the collaboration data stores include individual promoter shares data 176, squad roster data 177, squad product data 178, and squad executable instructions 179. Other types of data may be stored in memory unit 113 as well. In some examples, the memory unit of the collaboration engine stores only a subset of the data sets and programs depicted in FIG. 2.

Individual promoter shares data 176 specifies how entity commissions the promotion group earns for one of the promoters promoting a product or brand sufficient to cause a commission trigger event will be allocated among the members of the promotion group. Examples of individual promoter shares established by a promotion group named Baller Squad are shown in FIGS. 5 and 6. A user interface for negotiating and establishing individual promoter shares is shown in FIG. 8.

As shown in FIGS. 5 and 6, the individual promoter shares may include different individual commission allocations for each promoter in the promotion group. However, in some examples the individual promoter shares are an equal allocation per promoter in the promotion group, such as each promoter receiving 20% of the entity commission earned from a commission trigger event among 5 promoters in a promotion group. In the example shown in FIGS. 5 and 6, one promoter has a 20% individual promoter share, two promoters have a 15% individual promoter share, and a fourth promoter has a 5% individual promoter share.

The individual promoter share may be specific to a given product or brand or may apply universally to all products and brands promoted by the promotion group. For example, FIG. 6 depicts individual promoter shares specific to the brand Adidas. Selecting a different brand or product from the drop-down list currently displaying Adidas in FIG. 6 would populate different individual promoter shares in the individual promoter share table displayed in FIG. 6.

Squad roster data 177 keeps track of the current members of a promotion group. In the present example, squad roster data includes pertinent information about the promoters in the promotion group, including names, pictures, popularity metrics, sales metrics, tenure, products and brands promoted, and other information.

The figures show various forms of squad roster data 177 displayed as part of user interfaces of collaboration management system 108. For example, FIG. 4 depicts squad roster data 177 for three different promotion groups, including picture icons for each promoter in the groups. FIG. 5 depicts squad roster data 177 for a particular promotion group, Baller Squad, including a picture and a name for each promoter along with individual promoter share percentages for each promoter. FIG. 6 displays squad roster data 177 for the Baller Squad in a table format, including names of the promoters and the individual promoter shares for the promoters.

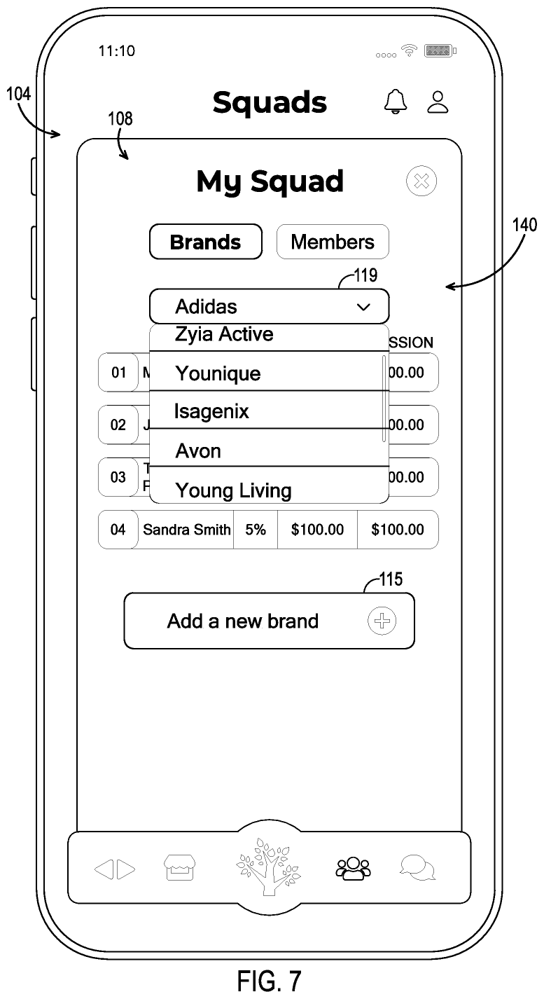

Squad product data 178 provides a record of the products or brands the promotion groups will promote. Squad product data 178 corresponds to a table of product or brand records associated with promotion groups. The product or brand data is obtained from memory unit 112 of attribution engine 102. As shown in FIG. 7, the product or brand data from memory unit 112 of attribution engine 102 may be accessed via a drop-down list 119 of a user interface of collaboration management system 108.

In some examples, as shown in FIGS. 6 and 7, one managing a promotion group may select brands or products to associate with the promotion group by clicking button 115 labeled “add new brand.” Button 115 displays a drop-down list of product or brand records, including information about the entity commission parameters associated with the products or brands. The drop-down list is populated with product or brand records from memory unit 112 of attribution engine 102.

FIG. 3 presents an example of a method for promoter collaboration 180 using collaborative marketing system 100. Method for promoter collaboration 180 depicted in FIG. 3 is executable by processor 100 shared by attribution engine 102 and collaboration engine 103 according to computer executable instructions stored in memory unit 113 of collaboration engine 103. Promoter collaboration method 180 depicted in FIG. 3 includes nine steps, but may include additional, fewer, or alternative steps in other examples.

As shown in FIG. 3, step 181 of method 180 is creating a promoter group, which is also referred to here as a squad or promotion group. Creating a promoter group at step 181 may include assigning a name, code, or label to the group for future reference. Creating a promoter group at step 181 will typically be initiated via collaboration management system 108 communicating with collaboration engine 103 via a user interface of promoter ecommerce system 104, such as the user interfaces shown in FIGS. 4-8.

With reference to FIG. 3, the reader can see that step 182 of method 180 is inviting promoters to join the promoter group. The promoters may be invited to join the promotion group at step 182 via user interfaces in the promoter ecommerce system 104, such as via button 114, labeled “add new member,” in the user interface shown in FIG. 5. The invitations may be communicated to the invited promoter's collaboration management system 108 or included in a message sent to the promoters outside collaborative marketing system 100, such as by email, text message, or a private message on a social media platform.

With continued reference to FIG. 3, step 183 of method 180 is selecting products or brands to be promoted by the promotion group. Selecting brands or products to associate with the promotion group at step 183 may occur by clicking button 115, labeled “add new brand,” on the user interface of promoter ecommerce system 104 shown in FIGS. 6 and 7. Button 115 displays a drop-down list of product or brand records, including entity commissions data 172 associated with the products or brands stored in memory unit 112 of attribution engine 102. The drop-down list displayed when button 115 is clicked is populated with product and brand records from product attributes 121 stored in memory unit 112 of attribution engine 102.

Steps 184-186 of method 180 involve setting, negotiating, and finalizing individual promoter shares to define how entity commissions will be allocated between the promoters of the promoter group. The entity commissions for a given product are obtained from entity commissions data 172 stored in memory unit 112. Individual promoter shares can be proposed, communicated, negotiated, finalized, and modified in steps 184-186 by the promotion group when needed. Negotiations may involve exchanging proposals back and forth via user interfaces of promoter collaboration management system 108, such as the user interface depicted in FIG. 8. Additionally or alternatively, negotiations of individual promoter shares may occur through messages outside the system.

Promoters who fail to reach an agreement on individual promoter shares may elect to opt out of the promotion group. Once the individual promoter shares are agreed upon by the promotion group members, the individual promoter shares may be finalized until subsequent changes are proposed. The promoter groups may begin earning entity commissions based on sales of products or promotions of brands by individual promoters on their individual promoter storefronts 105 once the promotion group is established and finalized. The entity commissions are subsequently allocated between the promoters in the group based on the individual promoter share data at step 189.

As shown in FIG. 3, step 187 of method 180 is to promote the promotion group's selected products. Promoting the promotion group's products at step 187 will typically occur on an individual promoter's storefront 105, such as storefront 150 depicted in FIG. 9 and storefront 160 depicted in FIG. 10. Each promoter in the promotion group may promote the group's products at step 105 in a unique way consistent with their style and independent views.

Method 180 proceeds with receiving a purchase order for one of the promotion group's products or brands at step 188. The purchase order for a product promoted by the promotion group may be received at step 188 via an individual storefront 105 of one of the promoters in the promotion group. The purchase order will typically be communicated to attribution engine 102 for processing and fulfilling the order.

A final step 189 in method 180 is allocating commissions to the promotion group promoters. The commissions allocated to the individual group promoters at step 189 will be portions of the overall entity commission amount(s) set by the commercial entities for the sale or promotion of the commercial entities' products. The portions of the overall entity commission amount(s) allocated to each promoter in the promoter group at step 189 will be based on the individual promoter shares agreed upon in steps 184-186. The commissions may be allocated to the promotion group promoters after each sale or may be batched and allocated in batches at defined intervals, such as once per month, once per week, once per day, or once per hour.

The reader should understand that the sequence of steps in method 180 may be different in other examples than depicted in FIG. 3. For instance, method 180 may entail selecting products to include in the promotion group at step 183 before inviting promoters to join the group at step 182.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

Claims:

1. A collaborative marketing system, comprising:
a processor configured to execute computer executable instructions;
an attribution engine in data communication with the processor and including an attribution memory unit with attribution data stores, the attribution data stores including:
a brand data store with information about brands of commercial entities available to collaboratively market in the collaborative marketing system;
a product data store with information about products of the commercial entities available to collaboratively market in the collaborative marketing system; and
an entity commissions data store with information about entity commissions the commercial entities will pay upon a brand or product marketed sufficient to cause a commission trigger event;
a collaboration engine including a collaboration memory unit in data communication with the processor, the collaboration memory unit including collaboration data stores with information about promoters utilizing the collaborative marketing system and about collaborations among the promoters; and
a promoter ecommerce system in data communication with the processor, the promoter ecommerce system including for each promoter utilizing the collaborative marketing system:
a promoter storefront customized by the promoter and accessible to consumer computing devices over a data network, the promoter storefront including:
marketing information deriving from the promoter about a selected brand or product from the attribution data stores; and
a commission trigger capturing when a commission trigger event occurs for the selected brand or product;
a collaboration management system configured to manage collaborative marketing by multiple promoters via promoter groups.

2. The collaborative marketing system of claim 1, wherein the collaboration management system includes a collaboration group interface configured to allow the promoters to establish the promoter groups and to selectively add and remove selected promoters from the promoter groups.

3. The collaborative marketing system of claim 2, wherein the collaboration group interface is configured to allow a given promoter to be included in multiple promoter groups.

4. The collaborative marketing system of claim 3, wherein the collaboration group interface is configured to allow the given promoter to associate different brands or products collaboratively marketed via the promoter storefront of the given promoter with different promoter groups.

5. The collaborative marketing system of claim 1, wherein the collaboration management system includes a commission share interface configured allow the promoters to establish and save in the collaboration memory unit individual promoter shares of a given entity commission that each promoter in a promoter group will earn when one of the promoters in the promoter group markets a brand or product sufficient to cause a commission trigger event.

6. The collaborative marketing system of claim 5, wherein the commission share interface is configured to allow the promoters in the promoter group to negotiate individual promoter shares.

7. The collaborative marketing system of claim 6, wherein the commission share interface is configured to allow the promoters to send an individual promoter share proposal to other promoters in the promoter group.

8. The collaborative marketing system of claim 7, wherein the commission share interface is configured to allow the promoters to accept or reject the individual promoter share proposal.

9. The collaborative marketing system of claim 7, wherein the commission share interface is configured to allow the promoters to send an individual promoter share counterproposal to other promoters in the promoter group.

10. The collaborative marketing system of claim 1, wherein the promoter collaboration management system includes a product selection interface allowing a promoter group to associate brands and/or products from the attribution data stores with the promoter group for the promoter group to collaboratively market.

11. The collaborative marketing system of claim 10, wherein:
the product selection interface includes a list of brands and products from the attribution data stores that the promoters may select to associate with the promoter group for collaborative marketing; and
the entity commission information from the entity commissions data store for each brand and product in the list of brands and products is associated with each brand and product in the list of brands and products to automatically establish the entity commission that the promoter group will earn when a commission trigger event for the selected brand or product occurs on the promoter storefront associated with one of the promoters in the promoter group.

12. The collaborative marketing system of claim 11, wherein the computer executable instructions include instructions for the processor to automatically allocate shares of the entity commission for a given product collaboratively marketed by the promoter group between the promoters in the promoter group according to predetermined individual promoter shares data for the promoter group saved in the collaboration memory unit.

13. The collaborative marketing system of claim 1, wherein:
the commission trigger event for a given product is a consumer purchasing the given product; and
the commission trigger on a promoter storefront is an ecommerce button for the consumer to selectively effectuate the purchase of the given product via a consumer computing device.

14. The collaborative marketing system of claim 13, wherein:
the promoter storefront is configured to allow the consumer to purchase multiple products in a single ecommerce transaction via the ecommerce button; and
the commission trigger event for the given product occurs when the consumer purchases multiple products including the given product in the single ecommerce transaction via the ecommerce button.

15. The collaborative marketing system of claim 14, wherein:
a second commission trigger event for a second product is a consumer purchasing the second product; and
the commission trigger event for the given product occurs and the second commission trigger event for the second product occurs when the consumer purchases multiple products including the given product and the second product in the single ecommerce transaction via the ecommerce button.

16. The collaborative marketing system of claim 1, wherein:
the commission trigger event for a given brand of a commercial entity is a consumer visiting a brand ecommerce system of the commercial entity; and
the commission trigger on the promoter storefront is a hyperlink to the brand ecommerce system of the commercial entity.

17. The collaborative marketing system of claim 1, wherein the promoter storefront includes marketing information about multiple brands and/or products.

18. The collaborative marketing system of claim 1, wherein the marketing information deriving from the promoter is a social media post.

19. The collaborative marketing system of claim 1, wherein the marketing information deriving from the promoter is an ecommerce product listing.

20. The collaborative marketing system of claim 19, wherein the promoter storefront includes ecommerce product listings of multiple products from different brands.
